(19) United States
(12) Patent Application Publication
(10) Pub. No.: US 2026/0020540 A1
(43) Pub. Date: Jan. 22, 2026

(54) Automated Pet Feeding Bowl Device

(71) Applicant: Robert Daniel, Cincinnati, OH (US)

(72) Inventor: Robert Daniel, Cincinnati, OH (US)

(21) Appl. No.: 18/910,143

(22) Filed: Oct. 9, 2024

Related U.S. Application Data
(60) Provisional application No. 63/671,797, filed on Jul. 16, 2024.

(51) Int. Cl. A01K 5/02; A01K 5/01; A01K 7/06

(52) U.S. Cl. CPC A01K 5/025; A01K 5/0142; A01K 5/0291; A01K 7/06

(57) ABSTRACT

A pet bowl device designed to enhance the feeding experience of pet animals is disclosed. The device features a sturdy, microwaveable bowl base. A transparent lid is hingedly connected to the base and is adapted to transition between open and closed states. The device incorporates a motion sensor that detects the movement or presence of a pet near the device and automatically transitions the lid between the open and closed states. The device also includes a programmable timer, controllable via a mobile application, which facilitates scheduled feeding. A camera system recognizes specific pets to allow access to designated animals only. The device also integrates a weight sensor for monitoring food quantities and a speaker to emit sounds based on set alerts.

### CROSS-REFERENCE TO RELATED APPLICATION

The present application claims priority to, and the benefit of, U.S. Provisional Application No. 63/671,797, which was filed on Jul. 16, 2024, and is incorporated herein by reference in its entirety.

### FIELD OF THE INVENTION

The present invention generally relates to the field of pet care accessories. More specifically, the present invention relates to an automated pet bowl designed to enhance feeding practices for domestic animals. The device incorporates a motion-activated lid, transparent for ease of monitoring by pet owners, which opens or closes based on the proximity of a pet using a motion sensor. The device ensures that food remains fresh and uncontaminated, thereby providing a hygienic, convenient feeding solution. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, pet bowls are used for feeding and drinking pets and are an essential part of a pet's kit. Often, pet owners leave food or water in bowls for their pets to consume later. Traditionally, pet bowls are left open, which makes them susceptible to various forms of contamination. Bowls left outdoors or in areas with high insect activity can attract bugs like ants, flies, and mosquitoes. These insects not only consume or spoil the food but can also spread diseases. Outdoor bowls are exposed to weather elements. Rain can fill the bowls with water, diluting nutrients in food and potentially leading to bacterial growth. Pets consuming contaminated food or water can suffer from gastrointestinal disturbances, infections, and other health problems.

Manual solutions like placing bowls under covered areas or using makeshift covers do not provide a reliable or convenient remedy for all conditions. Some conventional pet bowls are covered pet bowls or automatic feeders. However, they cannot react dynamically to the presence of the pet. It is impossible for pets to open the lid of conventional covered pet bowls. People desire a pet bowl device, which only opens when the pet approaches, effectively keeping out insects and minimizing exposure to dirt and rain.

Therefore, there exists a long-felt need in the art for an automated pet bowl that improves hygiene and convenience in feeding pets such as dogs and cats. Additionally, there is a long-felt need in the art for a pet bowl that prevents the contamination of food by insects, dirt, and environmental elements. Furthermore, there is a long-felt need for a pet bowl that operates efficiently to automatically open when the pet is near and close after the pet leaves. Moreover, there is a long-felt need in the art for an improved motion-activated pet bowl that prevents insects, dirt, and rain from infiltrating the bowl. Finally, there is a long-felt need for a pet bowl that minimizes food waste and ensures that pets have access to fresh food and water as needed without owner intervention.

The subject matter disclosed and claimed herein, in one embodiment thereof, comprises an automated pet bowl device. The device is designed to provide controlled access to food or water for pets like dogs and cats. The bowl comprises a stable base with a non-slip bottom and an automated transparent lid connected via a hinge. A motion sensor detects when a pet is nearby, triggering a microcontroller to signal an actuator that opens the lid, allowing the pet access to food. The lid remains closed when no pet is detected, preventing contamination. Additional embodiments include features such as programmable timers, pet recognition cameras, weight sensors for portion control, and built-in speakers for alerts. The device is constructed from microwave-safe materials and may include antimicrobial coatings, cooling, or heating elements for enhanced functionality.

In this manner, the automated pet bowl device of the present invention accomplishes all of the foregoing objectives and provides a novel solution that enhances pet feeding hygiene, convenience, and safety. The automated lid prevents unwanted contaminants from entering the bowl, thereby ensuring that pets consume only fresh, clean food and water. The device includes a motion-activated sensor to open the lid when a pet arrives at the bowl and close the lid when the pet departs. The device minimizes food waste and ensures that pets have access to fresh food and water as needed without owner intervention.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet bowl device. The pet bowl device comprises a bowl base configured to receive food or water for a pet, wherein the bowl base is geometrically shaped as one of round, square, or rectangular, and comprises a non-slip bottom surface to prevent sliding on a floor. A transparent lid is operatively connected to the bowl base via a hinge, the lid is adapted to transition automatically between an open state and a closed state. A motion sensor is configured to detect movement around the pet bowl device and to control the state of the lid based on the detected movement.

In another embodiment, a pet bowl device is disclosed. The device includes a microwaveable bowl base to accommodate pet food items, the bowl base is designed to be sturdy and stable to prevent tipping and to include a non-slip bottom surface. A hinge-connected transparent lid is capable of covering the bowl base, wherein the lid transitions automatically between an open state allowing access to the bowl base, and a closed state covering the bowl base. A passive infrared (PIR) sensor or an ultrasonic sensor is disposed to detect movement near the bowl base and to signal a microcontroller to control the opening and closing of the lid based on the movement.

In still another embodiment, a pet feeding apparatus is described. The apparatus includes a bowl base having a non-slip bottom and is configured to hold food or water, wherein the bowl base is made of a material suitable for microwave use. An automated lid is made of transparent material and is connected to the bowl base by a hinge, wherein the lid is adapted to automatically move between an open position and a closed position to protect the contents of the bowl base. An electronic control system includes a motion sensor for detecting a pet's presence near the device and a microcontroller configured to process signals from the motion sensor to operate an actuator that controls the hinge, thereby transitioning the lid position between the open position and the closed position based on the presence of the pet.

In still another aspect, a pet bowl device is disclosed. The device includes a bowl base configured to hold food or water for a pet, wherein the bowl base is constructed from a microwaveable material. A transparent lid is hingedly connected to the bowl base, capable of transitioning between an open state that allows access to the contents of the bowl base and a closed state that covers the bowl base to protect the contents. A motion sensor is configured to detect the presence of a pet near the bowl base and to trigger an opening of the lid. A programmable timer is capable of being set to automatically open the lid at pre-determined times, wherein the timer is programmable via a software application installed on a mobile device. A camera is integrated with the device for recognizing specific pets, thereby allowing only authorized pets to access the contents of the bowl base.

In yet another embodiment, a weight sensor display is embedded within the bowl base to indicate the weight of the food placed within, the display helps in adjusting portion sizes based on the pet's dietary needs.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the pet bowl device of the present invention in accordance with the disclosed structure;

FIG. 2 illustrates a perspective view showing the pet bowl device of FIG. 1 in a closed position in accordance with the disclosed structure;

FIG. 3 illustrates a schematic view showing the electronic components used in the pet bowl device of the present invention in accordance with the disclosed structure;

FIG. 4 illustrates a perspective view of another embodiment of the pet bowl device of the present invention in accordance with one embodiment of the present invention; and

FIG. 5 illustrates a perspective view showing the pet bowl device 400 in an open state when a pet stands near the pet bowl device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an automated pet bowl that improves hygiene and convenience in feeding pets such as dogs and cats. Additionally, there is a long-felt need in the art for a pet bowl that prevents the contamination of food by insects, dirt, and environmental elements. Furthermore, there is a long-felt need for a pet bowl that operates efficiently to automatically open when the pet is near and close after the pet leaves. Moreover, there is a long-felt need in the art for an improved motion-activated pet bowl that prevents insects, dirt, and rain from infiltrating the bowl. Finally, there is a long-felt need for a pet bowl that minimizes food waste and ensures that pets have access to fresh food and water as needed without owner intervention.

The present invention, in one exemplary embodiment, is a pet feeding apparatus. The apparatus includes a microwaveable bowl base to accommodate pet food items, the bowl base is designed to be sturdy and stable to prevent tipping and to include a non-slip bottom surface. A hinge-connected transparent lid is capable of covering the bowl base, wherein the lid transitions automatically between an open state allowing access to the bowl base, and a closed state covering the bowl base. A passive infrared (PIR) sensor or an ultrasonic sensor is disposed to detect movement near the bowl base and to signal a microcontroller to control the opening and closing of the lid based on the movement.

Reference will now be made in detail to the present preferred embodiments of the invention, examples of which are illustrated in the accompanying drawings. Wherever possible, the same reference numerals are used in the drawings and the description to refer to the same or like parts.

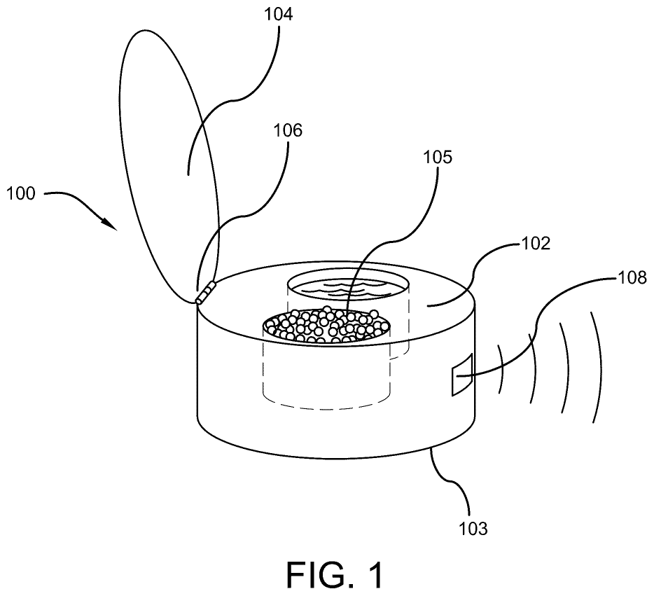

Referring initially to the drawings, FIG. 1 illustrates a perspective view of pet bowl device of the present invention in accordance with the disclosed structure. The pet bowl device 100 of the present invention is designed as a novel bowl for pets such as but not limited to dogs and cats. The pet bowl 100 is made of a microwaveable material such as non-toxic plastic or composite material and the bowl is safe for microwave use, allowing for easy heating of pet food. The pet bowl 100 includes a bowl base 102. The base 102 is comprised of an interior cavity 105 used for placing food or water for a pet. The bowl base 102 can be of any geometric shape, but is preferably generally round, square, or rectangular. The bowl base 102 is sturdy and stable, thereby preventing tipping thereof. The bottom surface 103 of the base 102 may be comprised of a non-slip material, such as but not limited to a non-slip textured (raised or recessed texture) rubber and does not slip or slide on a floor without intentional pushing or pulling by a user.

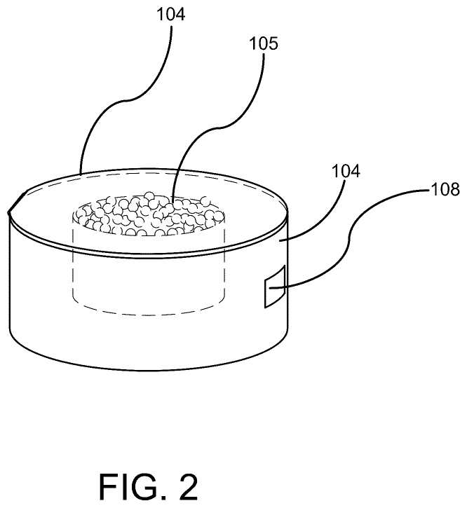

At least one automated transparent lid 104 is operatively connected to the base 102 using at least one spring-assisted or motorized hinge 106. The lid 104 is transparent allowing both pet and pet owners to see the food or water in the base 102 within the cavity 105. The lid 104 is adapted to automatically transition between an open state as illustrated in FIG. 1 and a closed state as illustrated in FIG. 2. In the open state, the lid 104 allows access to food when the pet is ready to cat without requiring human intervention. In the closed state, the lid 104 covers the base 102 and protects the food items or water placed in the base 102 from dirt, insects, etc., wherein the lid 104 attaches to the base 102 via at least one locking mechanism 110.

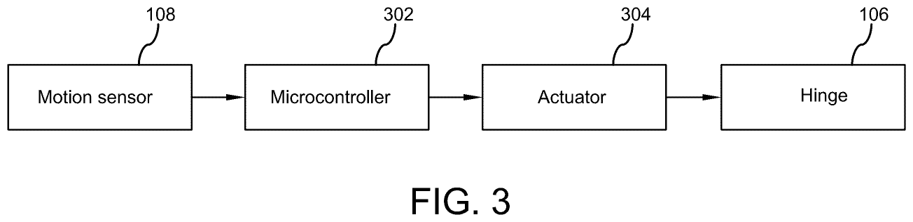

The pet bowl 100 includes at least one motion sensor 108 configured to detect movement around the pet bowl 100. The motion sensor 108 is preferably a passive infrared (PIR) sensor but can also be an ultrasonic sensor. When the motion sensor 108 detects movement of a pet around the bowl 100, the lid 104 is automatically opened via the hinge 106 as described in FIG. 3 for providing access to food or water to the pet.

FIG. 2 illustrates a perspective view showing the pet bowl device of FIG. 1 in a closed position in accordance with the disclosed structure. In the closed position or state, the lid 104 covers the bowl base 102 and access to the inner space 105 of the bowl base 102 is prevented. In the preferred embodiment, when the movement of a pet around the device 100 is not detected, the lid 104 remains in the closed state and is secured to the base 102 via the locking mechanism 110, which is preferably not limited to an electronic locking mechanism.

FIG. 3 illustrates a schematic view showing the electronic components used in the pet bowl device of the present invention in accordance with the disclosed structure. As illustrated, a microcontroller 302 is included in the device 100 for receiving and processing a motion detection signal from the motion sensor 108. Based on the processing of the signal, the microcontroller 302 sends a signal to an actuator 304 operatively connected to the hinge 106 and on receiving the signal, the actuator 304 activates the hinge 106 to automatically open the lid 104. The actuator 304 may also engage and disengage the locking mechanism 110. The microcontroller 302 continuously manages the time of opening the lid 104, thereby maintaining the lid 104 in the open state as long as the pet is in proximity and closes the lid 104 after the departure of the pet from near the device 100. In the preferred embodiment, the microcontroller 302 sends the signal to the actuator 302 when the microcontroller 302 receives the motion detection signal from the sensor 108 continuously for a predetermined time such as 5 seconds or 10 seconds to reduce false positives (when a pet passes through near the device 100 but does not stop for eating from the device 100) of opening the lid 104.

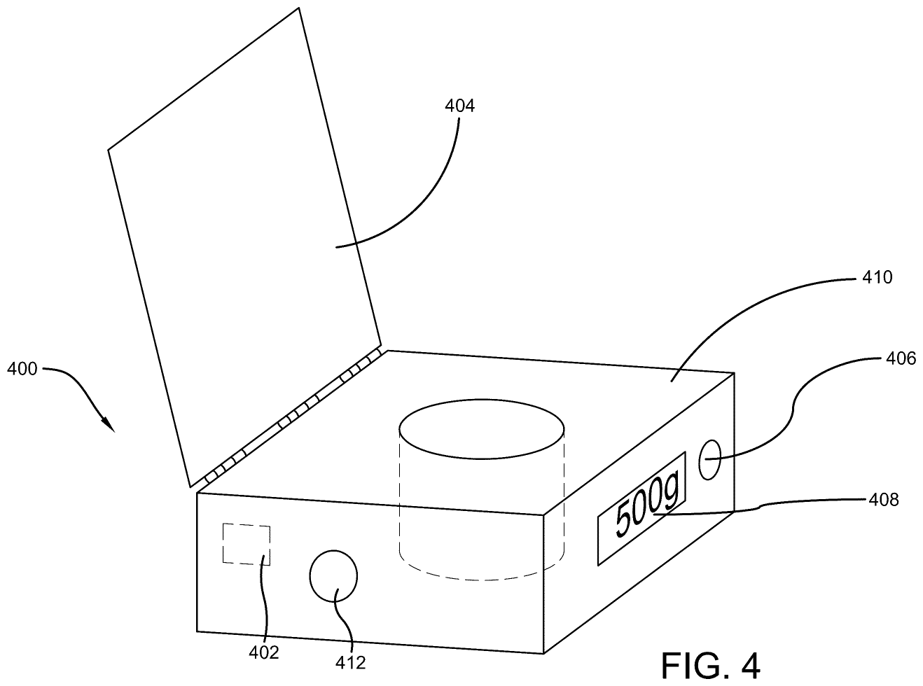

FIG. 4 illustrates a perspective view of another embodiment of the pet bowl device of the present invention in accordance with one embodiment of the present invention. In the present embodiment, the pet bowl device 400 includes all the features present in the device 100 of FIG. 1. Additionally, the device 400 includes a programmable timer 402 which can be programmed using a software application 414 installed in a mobile device to automatically open the lid 404. The device 400 is comprised of a camera 406 included for recognizing a specific pet via their appearance, thereby allowing only authorized pets to access the food placed in the pet bowl device 400. This is useful for homes with multiple animals and where each pet has individual and separate pet bowl device 100. A weight sensor display 408 is disposed in the bowl base 410 for displaying the weight of the food placed in the device 400 allowing a user to adjust portion sizes based on a pet's dietary needs. A speaker 412 is included in the device 400 and is configured to play an alert sound at a preprogrammed time such as feeding time for a pet, wherein the lid 104 opens.

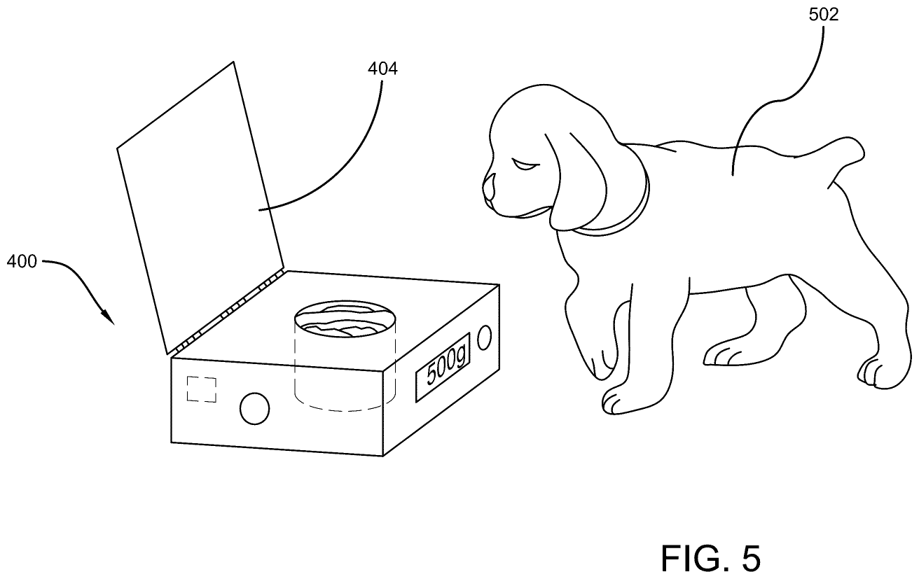

FIG. 5 illustrates a perspective view showing the pet bowl device 400 in an open state when a pet stands near the pet bowl device in accordance with the disclosed structure. The present embodiment is described for the automated pet feeding device 400 as an example and is applicable to all the embodiments described in the present disclosure. As illustrated, when a pet 502 stands near the device 400 for a predetermined time, the lid 404 is automatically opened based on detection of the pet 502 via the sensor 108, thus allowing the pet 502 to eat the food or water within the cavity 105. When the pet 502 is not in the vicinity of the device 400 (as detected by the sensor 108), the lid 404 is automatically closed to protect the device 400 and the food item therein.

The automated pet feeding device of the present invention can be made in various sizes to accommodate different pet sizes and food volume requirements. The bowl device may have antimicrobial coatings to keep the feeding area hygienic. The lid can be removed and interchanged. Further, the bowl base can embed cooling elements for water or heating elements for food.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automated pet feeding device”, “pet bowl device”, “pet feeding apparatus”, and “device” are interchangeable and refer to the automated pet feeding bowl device 100 of the present invention.

Notwithstanding the forgoing, the automated pet feeding bowl device 100 of the present invention can be of any suitable size and configuration as is known in the art without affecting the overall concept of the invention, provided that it accomplishes the above stated objectives. One of ordinary skill in the art will appreciate that the automated pet feeding bowl device 100 as shown in the FIGS. are for illustrative purposes only, and that many other sizes and shapes of the automated pet feeding bowl device 100 are well within the scope of the present disclosure. Although the dimensions of the automated pet feeding bowl device 100 are important design parameters for user convenience, the automated pet feeding bowl device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A pet bowl device comprising:
a bowl base comprised of an interior cavity;
a lid connected to the bowl base via a hinge, the lid being automatically transitional between an open state and a closed state;
an electronic locking mechanism for securing the lid to the bowl base in the closed state;
a motion sensor configured to detect the movement of a pet near the pet bowl device; and
a microcontroller configured to receive a signal from the motion sensor and, in response to detecting the movement of the pet, to activate the hinge to transition the lid from the closed state to the open state; and
wherein the motion sensor is an ultrasonic sensor.

2. The pet bowl device of claim 1, wherein the hinge is comprised of a spring-assisted hinge.

3. (canceled)

4. (canceled)

5. The pet bowl device of claim 1 further comprised of an actuator connected to the hinge, wherein the microcontroller is configured to activate the actuator to open the lid upon detecting movement of the pet.

6. The pet bowl device of claim 1, wherein the microcontroller is configured to keep the lid open for a predetermined time after the pet departs from proximity to the device.

7. A pet bowl device comprising:
a bowl base comprised of a microwaveable material, the bowl base comprised of an interior cavity;
a lid connected to the bowl base via a motorized hinge, the lid being automatically transitional between an open state and a closed state;
a speaker configured to play a sound at a programmable feeding time;
an electronic locking mechanism for securing the lid to the bowl base in the closed state; and
a microcontroller configured to receive a signal from a motion sensor and to control the motorized hinge to automatically open and close the lid based on the proximity of a pet.

8. The pet bowl device of claim 7, wherein the microwaveable material is comprised of a non-toxic plastic.

9. The pet bowl device of claim 7, wherein the lid is comprised of a transparent material allowing a visual access to the interior cavity.

10. The pet bowl device of claim 7, wherein the motorized hinge is activated by an actuator in response to a signal from the microcontroller.

11. The pet bowl device of claim 7 further comprised of a weight sensor disposed in the interior cavity to measure an amount of food or an amount of water positioned within the interior cavity.

12. (canceled)

13. A pet bowl device comprising:
a bowl base comprised of an interior cavity and a non-slip bottom surface;
a transparent lid connected to the bowl base via a motorized hinge;
a motion sensor configured to detect the movement of a pet near the pet bowl device;
a microcontroller configured to receive a signal from a motion sensor and to control the motorized hinge to automatically open and close the lid; and
a programmable timer configured to automatically open the transparent lid based on a pre-set schedule; and
wherein the motion sensor is an ultrasonic sensor; and
wherein the non-slip bottom surface is comprised of a recessed textured rubber.

14. (canceled)

15. (canceled)

16. The pet bowl device of claim 13 further comprised of a camera.

17. The pet bowl device of claim 13, wherein the microcontroller activates the motorized hinge after detecting movement continuously for a predetermined time.

18. The pet bowl device of claim 16, wherein the camera is configured to recognize a pet.

19. The pet bowl device of claim 13, wherein the microcontroller is configured to close the lid automatically after a predetermined period of inactivity detected by the motion sensor.

20. The pet bowl device of claim 13, wherein the bowl base is comprised of a round shape.
